(19) United States
(12) Patent Application Publication
(10) Pub. No.: US 2007/0042314 A1
(43) Pub. Date: Feb. 22, 2007

(54) Crimpable orthodontic device

(76) Inventor: David Brosius, Crete, IL (US)

Correspondence Address: SCHWARTZ COOPER CHARTERED;IP DEPARTMENT, 180 NORTH LASALLE STREET, SUITE 2700, CHICAGO, IL, 60601, US

(21) Appl. No.: 11/209,055

(22) Filed: Aug. 22, 2005

(51) Int. Cl. A61C 3/00

(52) U.S. Cl. 433/22

(57) ABSTRACT

A crimpable orthodontic device is disclosed. The orthodontic device is adapted to be mounted on an orthodontic wire. The crimpable orthodontic device has a tubular member defining an opening for receiving the orthodontic wire. The tubular member has an inner surface for contacting the orthodontic wire. The inner surface has an etched surface area on at least a portion of the inner surface of the tubular member. The tubular member is crimpable such that upon crimping on the orthodontic wire the etched surface area on the portion of the inner surface of the tubular member engages the orthodontic wire to increase the friction between the member and the orthodontic wire.

### TECHNICAL FIELD

This invention relates to an improved orthodontic device. More particularly, this invention relates to a crimpable member or body mountable on an orthodontic wire, wherein the inner surfaces of the crimpable member which contact the orthodontic wire are etched to increase friction and resist slippage along the orthodontic wire when the crimpable member is crimped down upon the wire.

### BACKGROUND OF THE INVENTION

Many types of crimpable orthodontic devices are disclosed in U.S. Pat. No. 4,639,219. The '219 patent provides a comprehensive background on the use of certain crimpable orthodontic devices for use on orthodontic wires and is hereby incorporated by reference as if fully set forth herein.

The crimpable orthodontic devices described in the '219 patent tend to slide along the orthodontic wire when forces are applied to them. This is considered a disadvantage or problem by some orthodontists who would prefer the device to remain in a fixed location on the orthodontic wire at all times.

One method of reducing the sliding of the crimpable hooks along the orthodontic wire is disclosed in U.S. Pat. No. 5,306,142, which is hereby incorporated by reference as if fully set forth herein. The '142 patent discloses a crimpable hook or stop having a tubular body with an abrasive material deposited on and coating an inner wire-engaging surface. This method has drawbacks including cost. Also, the coating could wear and/or fall off, or the coating could be scratched or pealed off.

The present invention is provided to solve the problems discussed above and other problems, and to provide advantages and aspects not provided by prior orthodontic devices of this type. A full discussion of the features and advantages of the present invention is deferred to the following detailed description, which proceeds with reference to the accompanying drawings.

### SUMMARY OF THE INVENTION

One object of the present invention is to provide a crimpable orthodontic device adapted to be mounted on an orthodontic wire and used for inter or intra arch traction. The crimpable orthodontic device comprises a tubular member defining an opening for receiving the orthodontic wire. The tubular member has an inner surface for contacting the orthodontic wire. The inner surface has an etched surface area on at least a portion of the inner surface. The tubular member is crimpable such that upon crimping on the orthodontic wire, the etched surface area on the inner surface of the tubular member engages the orthodontic wire to increase the friction between the member and the orthodontic wire.

The tubular member may be peripherally closed and mountable on the orthodontic wire prior to positioning of the orthodontic wire.

The tubular member may be peripherally split and mountable on the orthodontic wire subsequent to positioning of the orthodontic wire in a person's mouth.

The etched surface area on the inner surface of the tubular member may be formed by wet etching, dry etching. stamping, and/or filing the inner surface.

The etched surface may be formed by chemically and/or physically removing material from the inner surface.

The etched surface may include a relief pattern.

The crimpable orthodontic device may further comprise a stem extending from the tubular member. The outer end of the stem may include an enlarged head. The head may be ball-shaped.

The tubular member may be rectangular in cross section and adapted to be used on rectangular wire.

Another object of the present invention is to provide a crimpable orthodontic stop adapted to be mounted on the wire of a lip bumper or face bow. The stop comprises a tubular member having an inner surface defining an opening for receiving the wire, and an etched surface area on at least a portion of the inner surface of the tubular member. The tubular member is crimpable such that upon being crimped on the wire, the inner surface of the tubular member engages the wire with sufficient friction that the orthodontic stop resists sliding along the wire.

The etched surface area on the inner surface of the tubular member may be formed by wet etching, dry etching, stamping, and/or filing the inner surface.

Another object of the present invention is to provide a method of preparing an inner surface of a crimpable orthodontic device adapted to be mounted on an orthodontic wire and used for inter or intra arch traction or a wire of a lip bumper or face bow. The method comprises the steps of providing a substantially tubular member having an inner surface defining an opening for receiving the orthodontic wire or wire, and roughening at least a portion of the inner surface by etching. The substantially tubular member is produced from a metallic material.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a front elevational view of the upper and lower dental arches having orthodontic brackets mounted on teeth;

FIG. 2 is an enlarged perspective view of a crimpable stop according to the invention having a split body and in the form prior to mounting and illustrating the etched surface on the inner surfaces of the split crimpable body;

FIG. 3 is a further enlarged cross-sectional view of the split crimpable body of the crimpable hook taken substantially along line 3-3 of FIG. 2 and further illustrating the etched surface on the inner surface of the split crimpable body;

FIG. 4 is a perspective view of the crimpable stop in FIG. 2 shown mounted on a section of wire with the split crimpable body closed and the indentations from crimping on the outer surface of the body;

FIG. 5 is an enlarged perspective view of a crimpable stop according to the invention having a split body and in the form prior to mounting and illustrating the etched surface on the entirety of the inner surfaces of the split crimpable body; and

FIG. 6 is a further enlarged cross-sectional view of the split crimpable body of the crimpable hook taken substantially along line 6-6 of FIG. 5 and further illustrating the etched surface on the inner surface of the split crimpable body.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

The present invention is directed to tubular and split orthodontic devices, such as stops, hooks cleats, lugs, etc., equipped with a high friction, non-slip surface to improve stability on an orthodontic wire such as an archwire. One of ordinary skill in the art would recognize that the principles of the present invention could be applied to any such orthodontic devices.

Referring to the drawings, and specifically to FIG. 1, an upper dental arch 20 and a lower dental arch 21 of a person are shown in a closed position. A plurality of teeth 22 of both arches 20, 21 are in the desired occlusion. Each tooth 22 on both arches 20, 21 has a band 23 suitably cemented around it. An orthodontic edgewise bracket 24 is affixed to each band at the labiobuccal side of the tooth 22. It should be noted that it is also well known in the art to bond an orthodontic bracket directly to a tooth 22. Each bracket 24 has a mesiodistally extending substantially rectangular slot 25 for receiving an archwire 26. Two archwires 26, one for the upper arch 20 and one for the lower arch 21, are serially secured in the respective slots of the brackets 24 by suitable ligatures 27.

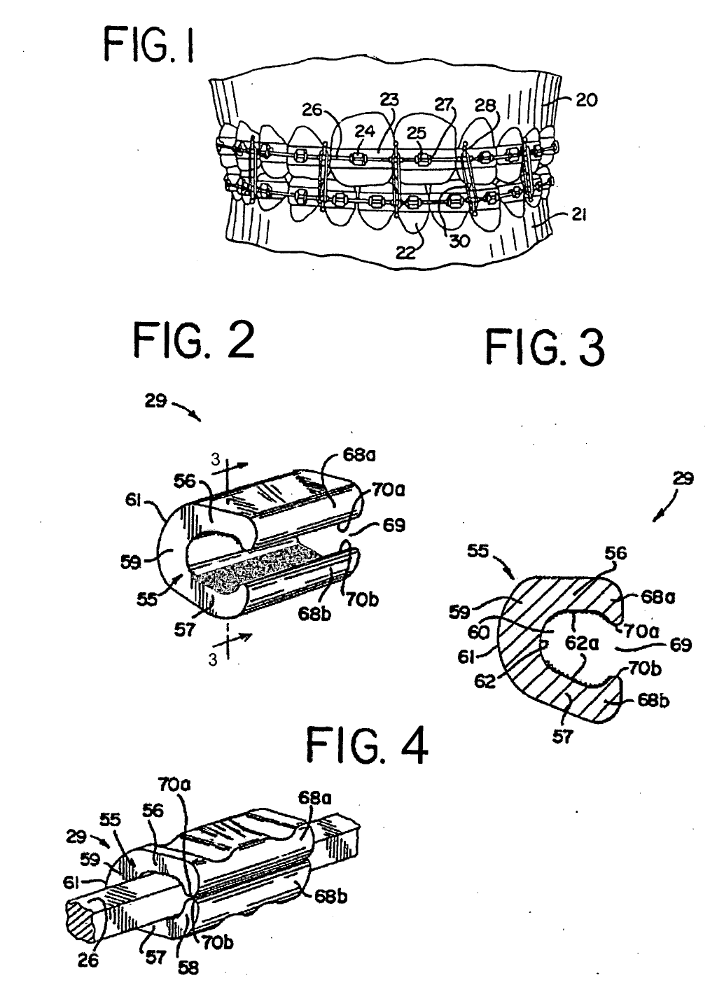

A tubular crimpable orthodontic device 28 such as a hook or stop of the present invention is mounted on the archwire, between two adjacent brackets 24, prior to or subsequent to placement of the archwire in the brackets 24. If mounted prior to placement, the orthodontic device 28 may be a tubular crimpable member. If mounted subsequent to placement, a peripherally split crimpable orthodontic device 28, similar to the stops illustrated in FIGS. 2-4, can be used.

Referring now to FIGS. 2 to 4, a split crimpable stop 29. The split crimpable stop 29 has a split tubular body or channel member 55 with a gingival side or wall 56, an occlusal side or wall 57, a lingual side or wall 58, and a labiobuccal side or wall 59 which define an archwire opening 60. The channel member 55 also has an outer surface 61 and an inner surface 62. Preferably, only that part of the inner surface at opposed walls 56 and 57 include a high friction or etched area, as these surface areas are crimped against the archwire.

The lingual side 58 is divided into two segments 68a and 68b, leaving a gap 69 at least slightly larger than the archwire to allow the channel member 55 to be mounted at any location on an archwire after the archwire is attached to the brackets. Each of these segments 68a and 68b of the lingual side 58 has an edge, 70a and 70b respectively, which are constructed to lock around the archwire when the channel member is properly crimped on an archwire.

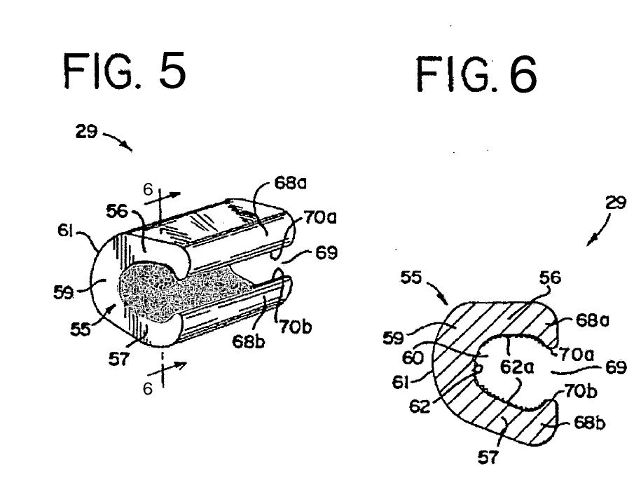

The inner surface 62 of the tubular member is supplied with a plurality of relief areas/lines or an etched surface area 62a, in its entirety or at selective areas. Preferably, the entire inner surface 62 is etched as illustrated in FIGS. 5 and 6. Alternatively, the etched surface area 62a is located only on the inside walls and not at the corners.

Etching is a preparation of a smooth surface by chemically or physically roughening it, including stamping, scraping, filing, laser treatment, heat treatment, etc. The etched surface area may be created by wet etching, where material is dissolved when immersed in a chemical solution, or dry etching, where material is sputtered or dissolved using reactive ions or a vapor phase etchant.

Wet etching is typically performed by masking a portion of the inner surface 62, and exposing the unmasked portion of the inner surface 62 to an acid. The acid eats the material, leaving behind relief and/or roughened areas, or if the surface exposed to the acid is very narrow, burning a line into the inner surface 62. The inner surface 62 may be covered in a hard, waxy ground that resists acid. Scratches or patterns are placed through the ground with a sharp point, exposing a pattern of the inner surface 62 that is attacked by the acid. Once the pattern in the ground is finished, the surface 62 is submerged in acid for a period of time; longer submersion means that deeper lines are etched. The ground is removed, or the surface 62 may be etched again in acid to deepen existing patterns while adding new patterns. The ground may also be reapplied to protect existing patterns while adding new ones. Again, however, it is preferable for the entire inner surface 62 to be etched where masking is unnecessary.

Alternatively, a resin may be evenly distributed on the inner surface 62, then heated to form a screen ground of uniform but less than perfect density. Preferably, after etching, the result is a uniformly relieved and/or roughened inner surface 62.

Dry etching is an etching process that does not utilize any liquid chemicals or etchants to remove materials from the inner surface 62. Dry etching may be accomplished by any of the following: 1) through chemical reactions that consume the material, using chemically reactive gases or plasma; 2) physical removal of the material, usually by momentum transfer; or 3) a combination of both physical removal and chemical reactions.

Plasma etching is an example of a purely chemical dry etching technique. Physical sputtering and ion beam milling are examples of purely physical dry etching techniques. Lastly, reactive ion etching is an example of dry etching that employs both physical and chemical processes.

Like wet etching, dry etching also follows the mask patterns on the inner surface 62a, i.e., it only etches away materials that are not covered by mask material (and are therefore exposed to its etching species), while leaving areas covered by the masks almost (but not perfectly) intact.

The function of the etched surface area 62a on the inner surface 62 of the crimpable tubular member 55 is best illustrated in FIG. 4 The tubular member 55 in FIG. 4 has been crimped such that the gingival side 56 and the occlusal side 57 are in a more parallel relationship and the edges 70a and 70b of the lingual side are in substantially abutting relationship to each other. The etched surface area 62a on the inner surfaces 62 of the channel member frictionally engages the wire at contact points under the crimps. The engagement of the wire and the etched surface 62a on the inner surface 62 of the member 55 at these contact points significantly increases the friction on the wire to a sufficient level to inhibit the tubular member 55 from sliding along and rotating on the wire.

While the devices 28 of FIG. 1 are illustrated as closed tubular members, one ordinary skilled in the art would appreciate that the devices 28 could be split similar to the stops illustrated in FIGS. 2-6. One ordinary skilled in the art would further appreciate that the tubular members may be cylindrically or rectangular shaped.

The crimpable orthodontic devices disclosed herein are typically produced from a metallic material, and may be cast or preferably flat stainless steel.

While the specific embodiments have been illustrated and described, numerous modifications come to mind without significantly departing from the spirit of the invention, and the scope of protection is only limited by the scope of the accompanying Claims.

1. A crimpable orthodontic device adapted to be mounted on an orthodontic wire comprising:
a tubular member defining an opening for receiving the orthodontic wire, the tubular member having an inner surface for contacting the orthodontic wire, the inner surface having an etched surface area on at least part of the inner surface of the tubular member, the tubular member being crimpable such that upon crimping on the orthodontic wire the etched surface area on the at least a portion of the inner surface of the tubular member engages the orthodontic wire to increase the friction between the member and the orthodontic wire.

2. The crimpable orthodontic device of claim 1 wherein the tubular member is peripherally closed and mountable on the orthodontic wire prior to positioning of the orthodontic wire.

3. The crimpable orthodontic device of claim 1 wherein the tubular member is peripherally split and mountable on the orthodontic wire subsequent to positioning of the orthodontic wire in a person's mouth.

4. The crimpable orthodontic device of claim 1 wherein the etched surface area on the inner surface of the tubular member is formed by wet etching.

5. The crimpable orthodontic device of claim 1 wherein the etched surface area on the inner surface of the tubular member is formed by dry etching.

6. The crimpable orthodontic device of claim 1 wherein the etched surface area on the inner surface of the tubular member is formed by stamping the inner surface.

7. The crimpable orthodontic device of claim 1 wherein the etched surface area on the inner surface of the tubular member is formed by filing the inner surface.

8. The crimpable orthodontic device of claim 1 wherein the etched surface area on the inner surface of the tubular member is formed by scratching the inner surface.

9. The crimpable orthodontic device of claim 1 wherein the etched surface area on the inner surface of the tubular member is formed by chemically removing material from the inner surface.

10. The crimpable orthodontic device of claim 1 wherein the etched surface area on the inner surface of the tubular member is formed by physically removing material from the inner surface.

11. The crimpable orthodontic device of claim 1 wherein the etched surface area on the inner surface of the tubular member includes a relief pattern.

12. The crimpable orthodontic device of claim 1 wherein the tubular member is rectangular in cross section and adapted to be used on rectangular wire.

13. A crimpable orthodontic stop adapted to be mounted on a wire of a lip bumper or face bow, the stop comprising:
a tubular member having an inner surface defining an opening for receiving the wire, an etched surface area on at least a portion of the inner surface of the tubular member, the tubular member being crimpable such that upon being crimped on the wire the inner surface of the tubular member engages the wire with sufficient friction that the orthodontic stop resists sliding along the wire.

14. The orthodontic crimpable stop of claim 13 wherein the etched surface area on the inner surface of the tubular member is formed by wet etching.

15. The orthodontic crimpable stop of claim 13 wherein the etched surface area on the inner surface of the tubular member is formed by dry etching.

16. The orthodontic crimpable stop of claim 13 wherein the etched surface area on the inner surface of the tubular member is formed by filing the inner surface.

17. A method of preparing an inner surface of a crimpable orthodontic device adapted to be mounted on an orthodontic wire, the method comprising the steps of:
providing a substantially tubular orthodontic member having an inner surface defining an opening for receiving the orthodontic wire, the substantially tubular orthodontic member being produced from a metallic material; and
roughening at least a portion of the inner surface by etching the metallic material.
